(19) United States
(12) Patent Application Publication
(10) Pub. No.: US 2021/0140915 A1
(43) Pub. Date: May 13, 2021

(54) GLASS ASSEMBLY, METHOD OF MAKING THE SAME AND ELECTROCHEMICAL SENSOR

(71) Applicant: Endress+Hauser Conducta GmbH+Co. KG, Gerlingen (DE)

(72) Inventors: Thomas Wilhelm, Chemnitz (DE); Matthäus Speck, Göpfersdorf (DE)

(21) Appl. No.: 17/096,383

(22) Filed: Nov. 12, 2020

(30) Foreign Application Priority Data
Nov. 12, 2019 (DE) 10 2019 130 474.1

(51) Int. Cl. G01N 27/36; C03B 23/13; C03B 23/09

(52) U.S. Cl. CPC G01N 27/36; C03B 23/099; C03B 23/097; C03B 23/13

(57) ABSTRACT

The present disclosure discloses a glass assembly, for forming an electrochemical sensor, comprising a glass immersion tube, a glass membrane connected to a distal end of the immersion tube, wherein the glass which forms the immersion tube contains no lead, no lead compound, no lithium, and no lithium compound.

### CROSS-REFERENCE TO RELATED APPLICATION

The present application is related to and claims the priority benefit of German Patent Application No. 10 2019 130 474.1, filed on Nov. 12, 2019, the entire contents of which are incorporated herein by reference.

### TECHNICAL FIELD

The present disclosure relates to a glass assembly, a method of making a glass assembly, and an electrochemical sensor.

### BACKGROUND

DE 101 16 075 C1 describes an automated method and a device for blowing a sensor membrane onto a glass immersion tube. This is referred to as a glass assembly. In this case, the immersion tube is immersed in a glass melt, remains there, is withdrawn again, and is blown to form a spherical membrane by means of a predetermined blow pressure curve. In the process, the geometry is monitored with a camera, and the process is ended on the basis of the camera information when a desired geometry is achieved.

DE 10 2014 116 579 A1 discloses an automated production of a glass assembly with a flat membrane.

DE 10 2015 114 334 A1 describes the monitoring and regulation of a production process for glass bodies for the production of pH electrodes.

Glass membranes for pH measurement usually consist of lithium-containing alkali glasses. The latter are generally blown onto Li-containing glass tubes. Here, the Li oxide content of the shaft glasses is ≥1 wt. %. The advantage of the lithium content is a better adaptation of the glass membrane in the contact zone between the different glasses, which manifests in an increased (thermo)mechanical stability. Moreover, the joining processes proceed more rapidly and controllably, which allows faster production of the sensor units.

It is disadvantageous that these glasses are less stable to hydrolysis or less resistant to extreme environmental influences.

An alternative approach for a well producible glass system is to use a lead-containing carrier glass. These glasses have very good processing properties and form very stable transition regions with pH glass membranes.

The use of lead oxide as a glass component is disadvantageous here. In addition to environmental, health, and occupational safety aspects, material availability plays an important role here. EP 1 505 388 discloses a glass shaft without the use of lead.

### SUMMARY

The object of the present disclosure is to provide a hydrolysis-resistant glass assembly which also satisfies environmental, health, and occupational safety aspects.

The object is achieved by a glass assembly comprising an immersion tube made of glass and a glass membrane connected to a distal end of the immersion tube, wherein the glass which forms the immersion tube contains no lead, no lead compound, no lithium, and no lithium compound.

One embodiment provides that the glass of the immersion tube is a borosilicate glass.

One embodiment provides that the glass of the immersion tube is a fiber glass, such as, including alkali-resistant fibers.

One embodiment provides that the glass of the immersion tube comprises at least SiO₂, B₂O₃, Al₂O₃, and Na₂O.

One embodiment provides that the composition is 65-75 wt. % SiO₂, ≤5 wt. % B₂O₃, ≤5 wt. % Al₂O₃, and 10-15 wt. % Na₂O.

One embodiment provides that the glass of the immersion tube furthermore comprises K₂O, BaO, CaO, and MgO, wherein the composition is respectively 1-10 wt. %.

The object is further achieved by an electrochemical sensor, such as, a pH sensor, comprising a glass assembly as described above, a measuring electrode, and a reference electrode. In one embodiment, the glass assembly comprises a diaphragm.

The object is further achieved by a method for producing a glass assembly as described above, comprising the steps of lowering an immersion tube in the direction of a glass melt; remaining in a defined position above the glass melt; immersing in the glass melt; remaining in the glass melt so that at the immersed end a film forms sealing the immersed end; raising the immersion tube with a first movement profile to a first level above the glass melt; charging the interior of the immersion tube with a blow pressure curve as of leaving the melt so that a membrane forms from the film at the end of the immersion tube; remaining at the first level; further raising the immersion tube with a second movement profile to a second level above the glass melt; and remaining at the second level.

One embodiment provides that the defined position above the glass melt is approximately 0.1 mm-15 mm above the glass melt.

One embodiment provides that the dwell time in the defined position above the glass melt is approximately 2-15 s.

One embodiment provides that the dwell time in the glass melt is approximately 0.5-1.5 s.

One embodiment provides that the dwell time at the first level is approximately 0.05-0.5 s.

One embodiment provides that the first level is approximately 0.1-15 mm above the glass melt.

One embodiment provides that the dwell time at the second level is shorter than 5 min, preferably shorter than 2 min, particularly preferably is 30-90 s.

One embodiment provides that the dwell time at the second level is approximately 1-5 s.

One embodiment provides that the second level is approximately 5-15 cm above the glass melt.

One embodiment provides that the temperature at the second level is between the transformation temperature of the glass of the immersion tube and the glass melt; this is preferably between 600° C. and 1200° C. or between 800° C. and 1000° C. In one embodiment, the temperature is thereby actively regulated. In one embodiment, the second level is defined such that the desired temperature is achieved.

### BRIEF DESCRIPTION OF THE DRAWINGS

This is explained in more detail with reference to the following figures.

FIG. 1 shows a device for producing the claimed glass assembly.

FIG. 2 shows a schematic depiction of the immersion depth.

### DETAILED DESCRIPTION

FIG. 1 shows a device 2 for producing a glass assembly. The device 2 comprises a glass melt device 4 which, for example, is formed by a crucible 6, such as a crucible 6 heated by an induction coil (not shown), that receives a glass melt 8.

The glass assembly first comprises an immersion tube 10 which is a glass tube. In addition to the immersion tube 10, the glass assembly comprises the membrane 11 to be formed later; see below. The glass tube 10 may, but does not necessarily need to, have a cylindrical symmetry. The glass which forms the immersion tube contains no lead, no lead compound, no lithium, and no lithium compound. It is, for instance, a borosilicate glass, for example a fiber glass with alkali-resistant fibers. The glass of the immersion tube comprises at least SiO₂, B₂O₃, Al₂O₃, and Na₂O. A possible composition of the glass comprises 65-75 wt. % SiO₂, ≤5 wt. % B₂O₃, ≤5 wt. % Al₂O₃, and 10-15 wt. % Na₂O. The glass of the immersion tube may furthermore comprise K₂O, BaO, CaO, and MgO, wherein these weight proportions are respectively approximately 1-10 wt. %. It is also possible that only one, two, or three compounds from the group of K₂O, BaO, CaO, and MgO is used as a component of the glass in addition to SiO₂, B₂O₃, Al₂O₃, and Na₂O.

The immersion tube 10 can be inserted into the crucible 6 via an opening 12 and be immersed into the glass melt 8. Immersing the immersion tube 10 in the glass melt 8 is achieved by lowering a holding device 14 for the immersion tube in the direction of the double arrow 16, i.e., toward the level of the glass melt 8. For this purpose, the device 2 comprises a positioning device 18 which may, if applicable, also be able to execute a movement along the double arrow 20, i.e., orthogonal to the lowering direction.

The positioning device 18 is connected to a control device 22 which, in the present example, is designed as a computer and which includes and may execute an operating program by means of which the movements of the positioning device 18 can be controlled. For this purpose, the control device 22 comprises a memory in which the operating program may be stored, as well as a processor that may access the memory to execute the operating program.

The device 2 comprises a pressure transducer 26 to apply a predeterminable gas pressure to the inside of the immersion tube 10. The pressure transducer 26 may, for example, comprise a pump device. The connection between the pump device 26 and the end of the immersion tube 10 that is pointing away from the glass melt 8 is provided via a flexible hose 28. The pressure transducer 26 is controlled by the control device 22 via a data transfer device 30. Also provided is a pressure measuring device 32 in the form of a pressure sensor that detects the pressure applied to the inside of the immersion tube 10 and conveys it to the control device 22 via a transmission device 34.

The pressure measuring device 32, in cooperation with the computer-assisted control device 22, forms a device for determining the position of the surface of the glass melt 8 in the crucible 6. For example, if a continuous, comparably very small gas or air flow is passed through the hose 28 and the immersion tube 10 by the pressure transducer 26, which flow leaves the immersion tube at its free end, a pressure increase occurs inside the immersion tube at the moment the free end of the immersion tube 10 touches the surface 42 of the glass melt as the holding fixture 14 is lowered in the direction of the melt 8. This pressure increase can be determined by means of the pressure sensor 32 and be passed on to the control device 22 via the transmission device 34. In this way, the glass melt 8 reaching the surface may be exactly ascertained. It is now possible to control the positioning device 18 in such a way that the immersion tube 10 is immersed in the glass melt 8 to an exact immersion depth h below the level 42.

The same result can, however, also be achieved if no continuous air or gas flow is passed through the hose 28 or the immersion tube 10. Namely, as it approaches the hot, liquid glass melt, the air or gas volume is increasingly heated inside the immersion tube 10 so that a spontaneous pressure increase inside the immersion tube results, which is also detectable by the pressure measuring device 32 or the pressure sensor and may be used for the control processes described above.

By incorporating the pressure measuring device 32 into the control of the pump device, a control loop may also be formed, by means of which a blow pressure curve stored in a memory of the control device 22 may be traversed to form the membrane 11; see below. The determination of reaching the surface of the glass melt according to one of the methods described above, and the traversal of the blow pressure curve, may be implemented by means of the control device 22 using the operating program.

The device 2 comprises an image capturing device 52, e.g., a digital camera, which is connected to the control device 22 so that the image data captured by the image capturing device, or image data that have been further analyzed, may be transferred to the control device 22. The control device 22 comprises an operating program which serves to process the image data, such as to compare the image data with target data stored in a memory of the control device 22. In the example shown here, the control device 22 therefore simultaneously serves as an image processing device. In an alternative embodiment, however, in addition to the control device 22, it is also possible to provide a further data processing device that serves as an image processing device and is connected to the control device for communication purposes in order to transmit to said control device the results of the comparison of the captured image data with stored target data. The image capturing device 52 is arranged approximately 5-15 cm, e.g., 10 cm, above the crucible.

Schematically depicted in FIG. 2 is the immersion depth h(t) as a function of the time t, i.e., the height h of the free end of the immersion tube 10 facing toward the glass melt 8 in relation to the level 42 of the glass melt. The surface 42 of the melt 8 thus corresponds to a height of “0.”

The glass tube 10 that should be provided with a membrane 11 is first fixed as an immersion tube 10 in the holding device 14 and is connected at one end via the hose 28 to the pressure transducer. The immersion tube 10 is driven in the direction of the melt 8. First, the immersion tube 10 is preheated over a predetermined preheating time t1, approximately 2-15 s, in that it is held at a predetermined small distance h1 above the hot glass melt 8. Since a certain amount of melt 8 is removed from the crucible 6 (see below), the fill level of the melt decreases with time. If the time t1 were kept constant, the glass tube 10 would be exposed to the temperature of the melt for a longer time due to the longer path of the immersion tube 10 into the melt 8. Thus, the time t1 is reduced with decreasing level 42.

The distance h1 may be a few millimeters. The immersion tube 10 is now vertically lowered to the surface of the glass melt 8 by controlling the positioning device accordingly. The tube axis, which may, for example, be a cylindrical symmetry axis of the immersion tube 10, thereby runs substantially vertically to the surface 42 of the glass melt 8. During the lowering of the immersion tube 10, the pressure inside the immersion tube 10 or inside the hose 28 is detected via the pressure measuring device 32 and passed on to the control device 22 via the transmission device 34. The moment the surface 42 is touched by the free end of the immersion tube 10, the air outlet is closed and the pressure inside the immersion tube 10 increases. The control device 22 uses this pressure increase to recognize that the surface 42 has been reached.

After it has recognized that the surface 42 has been reached, the control device 22 controls the positioning device 18 in such a way that the immersion tube 10 is immersed in the glass melt 8 to a predetermined immersion depth h2. The immersion tube 10 remains in this position for a predetermined dwell time t2, approximately 0.5-1.5 s. Due to the high viscosity of the glass melt 8, a film sealing the end of the immersion tube 10 thereby forms. The immersion tube 10 thereby removes a certain amount of glass from the melt.

After the dwell time t2 in the melt has elapsed, the control device 22 controls the positioning device 18 the immersion tube 10 upward with a predetermined first movement profile p1 in the direction perpendicular to the surface 42 of the glass melt 8 while controlling the pressure prevailing inside the immersion tube 10. The film is thereby somewhat enlarged. The immersion tube 10 reaches the height h3 and remains there for the time t3. The movement profile p1 comprises the path from h2 to h3 with a fixed jerk, acceleration, and velocity. For example, the velocity is 20-100 mm/s with the maximum possible acceleration of the respective motors.

The time t3 may be approximately 0.1 s to 1 s. The height h3 is approximately 10 mm. As mentioned, the immersion tube 10 receives a certain amount of glass from the melt 8 at the height h2. Depending on the velocity of the movement from h2 to h3, the received glass melt may in part “drip off” back into the crucible. A faster withdrawal prevents this. This is essentially related to the temperature of the melt 8; namely, if it is driven more slowly, the immersion tube 10 with the received glass melt is subjected to the high temperatures for a longer time, the glass remains liquid and drips back into the crucible 6.

In one embodiment, the time t3 is even shorter than 0.1 s, approximately 0.01 s, and is thus barely noticeable. The time t3 also depends on the glass composition of the melt 8. There are compositions that entrain a “glass thread” upon movement in the direction h3. Remaining at h3 may ensure that this glass thread is drawn to the glass tube 10 and ultimately disappears.

The heights h1 and h3 may be the same or different.

After the time t3 above the surface 42 of the glass melt 8, the control device 22 continues raising the immersion tube 10 with a movement profile p2. The movement profile p2 comprises the path from h3 to h4 with a fixed jerk, acceleration, and velocity. The jerk, acceleration, and velocity may be the same as or different from p1. As a rule, however, at least a greater velocity is selected here than in p1. The velocity is the slope in the diagram in FIG. 2. It is apparent here that p2 has a greater slope than p1. The distance from h3 to h4 is longer than from h2 to h3; a greater velocity may thus also be achieved.

The immersion tube 10 is then raised to a predetermined height h4 at which the end of the immersion tube 10 comprising the film may be detected by an image capturing device 52 during the cooling of the film. The blow pressure curve stored in the memory is active for the duration of the immersion tube movement from h1 to h4, i.e., for the duration in which the camera cannot yet determine a diameter or other measurement parameters. A constant pressure is applied as of approximately the height h1 (see above), i.e., also during the immersion (h2). A variable pressure according to the blow pressure curve is applied as of leaving the melt (reference sign 36). The membrane 11 is thereby already inflated to a certain degree before reaching the height h4, e.g., up to a diameter of 50-80% of the final diameter. If the camera 52 determines a measured value within a defined value range at the height h4, it takes over the regulation of the membrane diameter. In this case, as of the height h4, the pressure on the membrane is controlled as a function of the current diameter, which is determined by the image capturing device 52.

As mentioned in the above paragraph, as of leaving the melt 8 (reference sign 36), a variable pressure is applied to form the membrane 11. However, this application of the variable pressure may be delayed for some time yet; this is indicated by the reference sign t5 in FIG. 2. This parameter t5, i.e., the wait time until the blow pressure curve starts, thus delays the activation of the blow pressure curve and ensures a time-shifted inflation. The greater that t5 is, the more the received glass quantity cools off (since it is moved and further away from the hot melt 8) and is thus blown out to be thinner. An earlier activation of the blow pressure curve (t5 is small) entails an earlier inflation. The glass received from the melt can be inflated more easily, pulls more glass with it, and the membrane thus becomes thicker.

The pressure prevailing in the immersion tube 10 is controlled by means of data captured by the image capturing device 52. The image capturing device 52 captures image data of the film and transfers said data to the control device 22. This control device then implements a comparison between the captured image data (actual data=current values) and stored target data. The control device 22 may also display the actual data and the target data via an output device 24, e.g., a monitor. Via the operating program of the control device 22 serving for image processing, the geometrical shape of the film may be computationally determined by means of an image or pattern recognition algorithm and be compared with the stored target data. On the basis of the comparison, the control device 22 controls the pressure transducer 26 until the film solidifies into a firm membrane, in order to adjust the geometry of the film to the target geometry corresponding to the stored target data. For this purpose, the immersion tube 10 remains at this height h4 for a time t4. This leads to the aforementioned post-heating, also referred to as tempering. The time t4 may be approximately 5-20 s. The height h4 is approximately 10 cm. A determination of the diameter, in general the shape, of the membrane 11 thus takes place by means of the camera 52. The temperature at the second level h4 is between the transformation temperature of the glass of the immersion tube and of the glass melt, that is to say approximately between 600° C. and 1200° C., preferably between 800° C. and 1000° C. An active regulation of the temperature takes place. Alternatively or additionally, the height of the second level h4 is chosen such that the desired temperature results at the corresponding height.

The camera 52 for the diameter regulation is located above the crucible 6, with its measuring axis approximately 10 cm above the crucible level 42. After the immersion tube 10 has been withdrawn, blowing may thus be implemented above the crucible 6 and subsequently the post-heating with the heat flow of the glass melt 8; see below. Experimental tests have shown that membrane cracking (see below) is also thereby reduced.

The device 2 furthermore comprises an additional image capturing device which is designed as a confocal measuring system 54. The confocal measuring system 54 is arranged at the same height as the camera 52, e.g., offset by 90 or 180°. The confocal measuring system 54 is likewise connected (not shown) to the controller 22. The wall thickness is measured optically and without contact using the confocal system 54. A broad light spectrum is emitted by the confocal measuring system 54, wherein corresponding reflections are generated as a function of the wall thickness, which reflections are analyzed. With the aid of these reflections, the wall thickness may be calculated using the respective refractive index. The confocal measuring system 54 thus determines the wall thickness and transmits it to the controller 22. If it is ascertained that the wall thickness is too large or small, one or more parameters of the production process are changed and adjusted for the next blowing process, e.g., the velocity to h3, generally all parameters of p1. In one embodiment, the camera 52 may also be used for this purpose.

The system 2 comprises a polarimeter 56 for the optical measurement of the mechanical stresses in the glass. The polarimeter 56 is arranged at the same height as the camera 52, e.g., offset by 90° or 180°. The polarimeter 56 is also connected (not shown) to the controller 22. With the polarimeter 56, the stress distribution in the light-permeable membrane 11 is examined via the use of polarized light. A high mechanical stress is an indication of the tendency to form cracks. It is also decisive where the highest mechanical stresses occur, e.g., near or opposite the immersion tube 10. Depending on the mechanical stress, one or more parameters of the production may be changed; see below. The polarimeter 56 thus determines the mechanical stresses and transmits them to the controller 22. If it is ascertained that the mechanical stress is too large or small, one or more parameters of the production process are changed and adjusted for the next blowing process, e.g., the preheating time t1 or the immersion duration t2.

A plurality of electrode assemblies 1 is produced in this way.

After the film has solidified into a firm membrane, the actual geometry, diameter, surface, mechanical stress, etc. of the membrane may be detected again and compared to the respective target data. On the basis of this comparison, the control unit 22 may perform a classification which may be a a measure of whether the assembly produced from the immersion tube 10 and the membrane must be treated as a reject or may be used for the production of an electrochemical sensor. In the latter instance, the assembly may be connected to components to form an electrochemical, such as a potentiometric pH sensor. The assembly is supplemented by a measuring electrode and a reference electrode. The glass assembly comprises a diaphragm. Via the diaphragm, the reference electrode is in electrical contact with the medium to be measured, wherein the diaphragm largely prevents material exchange with the medium to be measured. The reference electrode comprises, for example, a silver wire, silver chloride, and an electrolyte solution, e.g., potassium chloride. In one embodiment, internal buffers into which the measuring electrode projects are arranged inside the glass assembly.

In principle, the blow pressure curve alone is only conditionally suitable as an actuating variable for regulating the wall thickness since a change in the blow curve leads to a change in the geometry of the produced glass membrane.

In order to keep the quality of the production process of the glass assembly constant, the wall thickness and the surface of the membrane are regulated, but without changing the geometry per se.

The wall thickness is influenced independently of the diameter of the glass membrane by varying the first movement profile p1, such as its withdrawal velocity. For a regulation, for each n-th component, e.g., each 5th component, a wall thickness measurement is implemented using the aforesaid confocal measuring device. This value is compared with a target value for the wall thickness. Based on this control difference, the profile p1, such as the velocity, is ultimately increased or reduced. This may occur automatically via the device, such as via the controller 22.

The quality, with respect to the tendency of the membrane to crack, of the bond between glass membrane and immersion tube 10 may be influenced by a plurality of parameters: the temperature of the melt 8; the preheating time, i.e., the time t1, thus the time during which the immersion tube 10 remains above the glass melt 8 before immersion, before it is immersed in the melt; and the the immersion duration t2 in the melt.

Given a preheating time t1 (see above) in the range of approximately 2-15 s, the susceptibility of a membrane to crack is markedly reduced, such as to crack along the mixing zone with the risk of the membrane falling off completely.

The values are different depending on the type and material composition of the immersion tube. Longer preheating times heat the immersion tube too much, and it deforms after the blowing or melts partly into the crucible upon immersion.

Depending on the membrane glass, the temperature of the glass melt 8 is 1000° C. to 1400° C. and conforms to, among other things, the viscosity of the glass.

A three-stage process thus results for the production: First, preheating and immersion take place for a correspondingly long time, which is important for the formation of cracks. The withdrawal velocity defines the wall thickness. Finally, the exact geometry, i.e., the shape and diameter of the membrane, results from the blowing of said membrane.

In this way, the wall thickness and surface of the membrane 11 of the glass bodies successively produced in series by means of the device 2 are measured in predetermined time windows, wherein the wall thicknesses and surfaces (or the mechanical stress) of a plurality of glass membranes are transmitted to the control device. The control device 22 stores these data in a memory and determines mean values from a predetermined number of wall thicknesses, which mean values are forwarded to a software-type controller embodied in the control device. Since the mean value is designed as a floating mean value in which the oldest value of the wall thickness is always eliminated and a next value of the wall thickness of a further glass body is added, a trend in the wall thickness of the glass bodies can preferably be ascertained.

Thus, after repeatedly ascertaining a deviation of the mean value of the actual wall thickness/surface from the predetermined target wall thickness/surface, the production-specific setting parameters (see above) of the production process of the individual glass body may be modified automatically so that the subsequently produced glass bodies have the desired target wall thickness/surface and thus the required quality. For example, it is possible to intervene if five successively produced glass assemblies deviate from a target value.

In one embodiment, the first five or ten immersion tubes of a new batch must always be monitored, and the parameters adjusted/regulated accordingly. The parameters of the subsequent immersion tubes of the batch are no longer regulated/adjusted, or no longer need to be adapted. In one embodiment, all immersion tubes of a batch are monitored, and the parameters are regulated.

By controlling the wall thickness of the membrane and/or the surface of the membrane via the above-described process parameters, it is above all possible to compensate factors which cannot be influenced or whose influence cannot be systematically compensated, such as the quality of the immersion tube 10 or slight deviations of the glass composition of the immersion tube 10.

1. A glass assembly for forming an electrochemical sensor, comprising
a glass immersion tube,
a glass membrane connected to a distal end of the immersion tube such that the glass which forms the immersion tube contains no lead and no lithium.

2. The glass assembly of claim 1, wherein the glass of the immersion tube is a borosilicate glass.

3. The glass assembly of claim 1, wherein the glass immersion tube is a fiber glass tube.

4. The glass assembly of claim 1, wherein the glass of the immersion tube comprises at least SiO₂, B₂O₃, Al₂O₃, and Na₂O.

5. The glass assembly of claim 4, wherein the composition is 65-75 wt. % SiO₂, ≤5 wt. % B₂O₃, ≤5 wt. % Al₂O₃, and 10-15 wt. % Na₂O.

6. The glass assembly of claim 1 wherein the glass of the immersion tube furthermore comprises K₂O, BaO, CaO, and MgO, wherein the proportions are respectively ≤10 wt. %.

7. An electrochemical sensor, comprising:
a glass assembly, a measuring electrode, and a reference electrode
wherein the glass assembly includes:
a glass immersion tube, and
a glass membrane connected to a distal end of the immersion tube such that the glass which forms the immersion tube contains no lead and no lithium.

8. A method for producing a glass assembly, wherein the glass assembly includes a glass immersion tube and a glass membrane connected to a distal end of the immersion tube such that the glass which forms the immersion tube contains no lead and no lithium, comprising the steps of:
lowering an immersion tube in the direction of a glass melt,
remaining in a defined position above the glass melt,
immersing in the glass melt,
remaining in the glass melt so that a film forms at the immersed end, said film sealing said end,
raising the immersion tube with a first movement profile to a first level above the glass melt,
charging the interior of the immersion tube with a blow pressure curve as of leaving the melt so that a membrane forms from the film at the end of the immersion tube, remaining at the first level,
further raising the immersion tube with a second movement profile to a second level above the glass melt, and
remaining at the second level.

9. The method of claim 8, wherein the defined position above the glass melt is approximately 0.1 mm-15 mm above the glass melt.

10. The method of claim 8, wherein the dwell time in the defined position above the glass melt is approximately 2-15 s.

11. The method of claim 8, wherein the dwell time in the glass melt (8) is approximately 0.5-1.5 s.

12. The method of claim 8, wherein the dwell time at the first level is 0.05-0.5 s.

13. The method of claim 8, wherein the first level is approximately 0.1-15 mm above the glass melt.

14. The method of claim 8, wherein the dwell time at the second level is shorter than 5 min.

15. The method of claim 8, wherein the dwell time at the second level is 1-5 s.

16. The method of claim 8, wherein the second level is 5-15 cm above the glass melt.

17. The method of claim 8, wherein the temperature at the second level is between the transformation temperature of the glass of the immersion tube and the glass melt.
